(19) United States
(12) Patent Application Publication
(10) Pub. No.: US 2026/0135317 A1
(43) Pub. Date: May 14, 2026

(54) TERMINAL MODULE WITH IMPROVED CONDUCTIVE TERMINALS, MANUFACTURING METHOD THEREOF, AND APPLICATION THEREOF

(71) Applicants: SPEED TECH CORPORATION, Taoyuan City (TW); ASSEM TECHNOLOGY CO., LTD., New Taipei City (TW)

(72) Inventors: Ho-Chang CHEN, Taoyuan City (TW); Shih-Tung LIN, Taoyuan City (TW); Hua-Chun CHANG, Taoyuan City (TW); LI-SEN CHEN, Taoyuan City (TW)

(73) Assignees: SPEED TECH CORPORATION, Taoyuan City (TW); ASSEM TECHNOLOGY CO., LTD., New Taipei City (TW)

(21) Appl. No.: 19/251,175

(22) Filed: Jun. 26, 2025

(30) Foreign Application Priority Data
Nov. 14, 2024 (CN) 202411622160.X
Feb. 21, 2025 (CN) 202510194304.4

(51) Int. Cl. H01R 13/405; H01R 13/6597; H01R 43/24

(52) U.S. Cl. CPC H01R 13/405; H01R 13/6597; H01R 43/24

(57) ABSTRACT

A terminal module includes a number of first conductive terminals, an insulating body and a first shielding piece. The first conductive terminal includes a first conductive pad, a second conductive pad and a first intermediate portion. The insulating body includes a first surface and a second surface. The first conductive pad is exposed on the first surface. The first intermediate portion includes a first embedded portion embedded in the insulating body, thereby facilitating increasing the retaining force between the first conductive terminal and the insulating body. The terminal module of the present disclosure is able to replace a printed circuit board in the related art, so as to be better adaptable to the development requirements of high-speed connectors in terms of dimension control and impedance adjustment. A method of manufacturing the terminal module and an application of the terminal module are also disclosed.

### CROSS-REFERENCE TO RELATED APPLICATIONS

This patent application claims priorities of a Chinese Patent Application No. 202510194304.4, filed on Feb. 21, 2025 and titled “TERMINAL MODULE, MANUFACTURING METHOD THEREOF, AND APPLICATION THEREOF”, and a Chinese Patent Application No. 202411622160.X, filed on Nov. 14, 2024 and titled “TERMINAL MODULE, MANUFACTURING METHOD THEREOF, AND APPLICATION THEREOF”, the entire contents of which are incorporated herein by reference in their entirety.

### TECHNICAL FIELD

The present disclosure relates to a terminal module, a manufacturing method of the terminal module, and an application of the terminal, which belongs to the technical field of electrical connector components.

### BACKGROUND

Some conventional electrical connectors include components made from printed circuit boards (PCBs), such as tongue plates or adapter modules. The PCB typically includes a plurality of first conductive pads, a plurality of second conductive pads, and a plurality of internal conductive traces formed inside the PCB.

However, it is understandable to those of ordinary skill in the art, due to limitations in PCB manufacturing processes, controlling geometric dimensions (e.g., thickness) is challenging, which leads to impedance mismatches and difficulties in meeting high-speed signal transmission requirements.

Therefore, it is desirable to improve the PCBs in the related technology.

### SUMMARY

The present disclosure adopts the following technical solution: a terminal module, including: a plurality of first conductive terminals, each first conductive terminal including a first conductive pad, a second conductive pad, and a first intermediate portion connecting the first conductive pad and the second conductive pad; the first conductive pad and the second conductive pad being disposed at intervals along a first direction; an insulating body, the insulating body including a first surface and a second surface disposed opposite to the first surface along a second direction that is perpendicular to the first direction; the first conductive pad being exposed on the first surface; the first intermediate portion extending from the first surface toward the second surface along the second direction; the first intermediate portion including a first embedded portion embedded in the insulating body and spaced away from the first conductive pad along the second direction; and a first shielding piece, the first shielding piece including a first plate portion at least partially embedded in the insulating body; the first embedded portion being located between the first conductive pad and the first plate portion along the second direction.

The present disclosure adopts the following technical solution: a method for manufacturing the above-mentioned terminal module, including: providing the plurality of first conductive terminals; providing the first shielding piece; injection-molding a first insulating block on the first conductive terminals and the first shielding piece to form a first terminal assembly; providing the plurality of second conductive terminals; providing the second shielding piece; injection-molding a second insulating block on the second conductive terminals and the second shielding piece to form a second terminal assembly; assembling the first terminal assembly and the second terminal assembly together; and injection-molding a third insulating block on the first terminal assembly and the second terminal assembly to form the insulating body.

The present disclosure adopts the following technical solution: an application of the above-mentioned terminal module, wherein the terminal module is a component of an electrical connector, and the terminal module is configured to replace a printed circuit board.

### BRIEF DESCRIPTION OF DRAWINGS

FIG. 1 is a perspective schematic view of a terminal module in accordance with a first embodiment of the present disclosure;

FIG. 2 is a perspective schematic view of FIG. 1 in another angle;

FIG. 3 is a top view of FIG. 1;

FIG. 4 is a bottom view of FIG. 1;

FIG. 5 is a partial perspective exploded view of FIG. 1;

FIG. 6 is a partial perspective exploded view of FIG. 5 in another angle;

FIG. 7 is a perspective exploded view of a first terminal assembly of FIG. 6;

FIG. 8 is a perspective exploded view of FIG. 7 in another angle;

FIG. 9 is a perspective exploded view of a second terminal assembly of FIG. 5;

FIG. 10 is a perspective exploded view of FIG. 9 in another angle;

FIG. 11 is a schematic cross-sectional view taken along line B-B of FIG. 1;

FIG. 12 is a perspective exploded view of the first terminal assembly of FIG. 7 in accordance with a second embodiment of the present disclosure;

FIG. 13 is a schematic cross-sectional view of the terminal module in accordance with a second embodiment of the present disclosure;

FIG. 14 is a schematic cross-sectional view of the terminal module in accordance with a third embodiment of the present disclosure;

FIG. 15 is a schematic cross-sectional view of the terminal module in accordance with a fourth embodiment of the present disclosure;

FIG. 16 is a schematic cross-sectional view of the terminal module in accordance with a fifth embodiment of the present disclosure;

FIG. 17 is a schematic view of the terminal module in one application of the present disclosure;

FIG. 18 is a schematic view of the terminal module in another application of the present disclosure;

FIG. 19 is a schematic cross-sectional view of the terminal module in accordance with a sixth embodiment of the present disclosure;

FIG. 20 is a partially enlarged view of circled portion C of FIG. 19;

FIG. 21 is a partially enlarged view of circled portion D of FIG. 19;

FIG. 22 is a schematic cross-sectional view of the terminal module in accordance with the sixth embodiment of the present disclosure;

FIG. 23 is a schematic cross-sectional view of the terminal module in accordance with a seventh embodiment of the present disclosure;

FIG. 24 is a schematic cross-sectional view of the terminal module in accordance with an eighth embodiment of the present disclosure;

FIG. 25 is a schematic cross-sectional view of the terminal module in accordance with a ninth embodiment of the present disclosure; and

FIG. 26 is a schematic cross-sectional view of the terminal module in accordance with a tenth embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

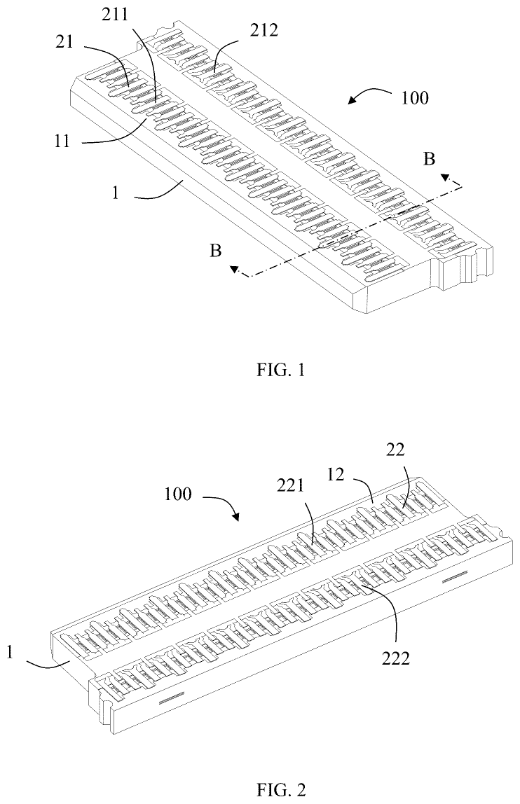

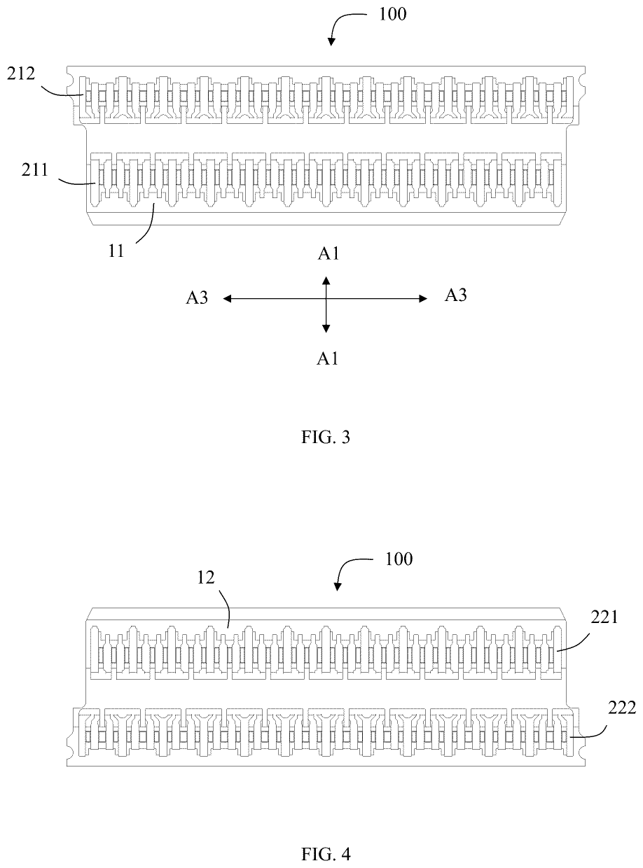

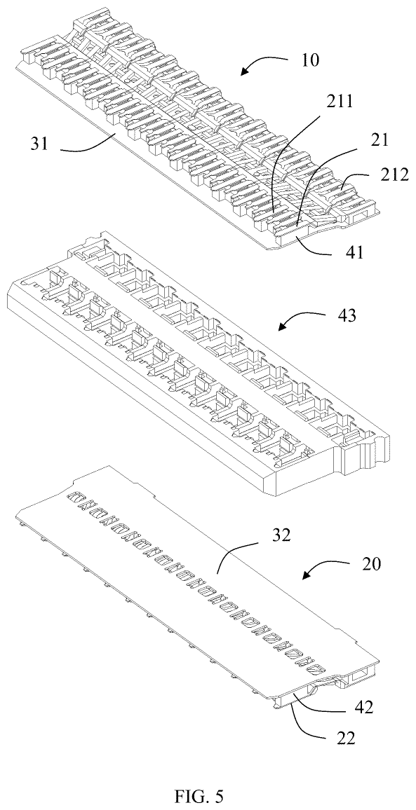

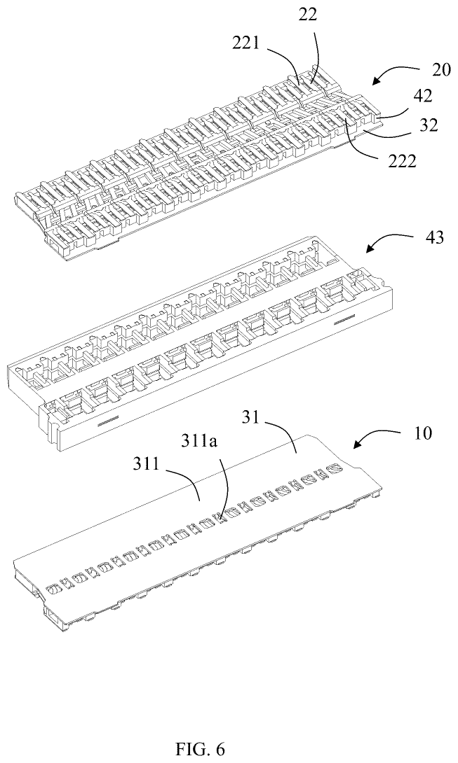

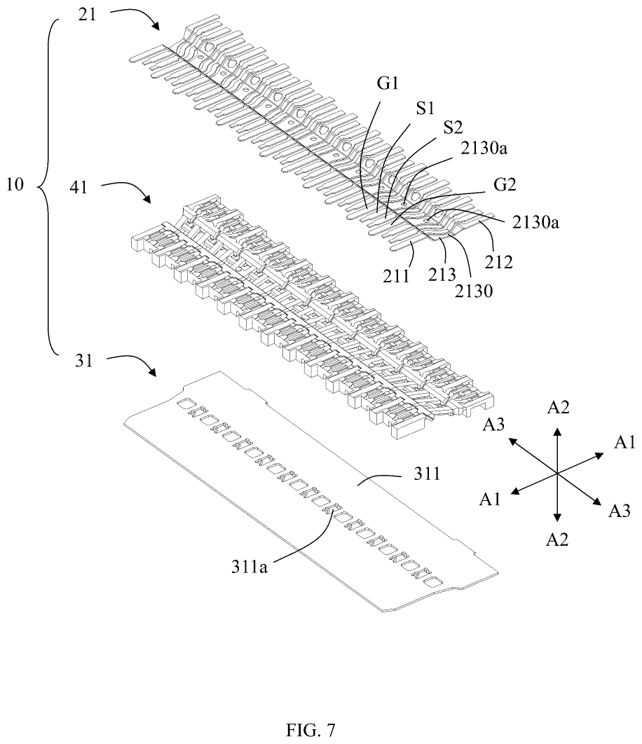

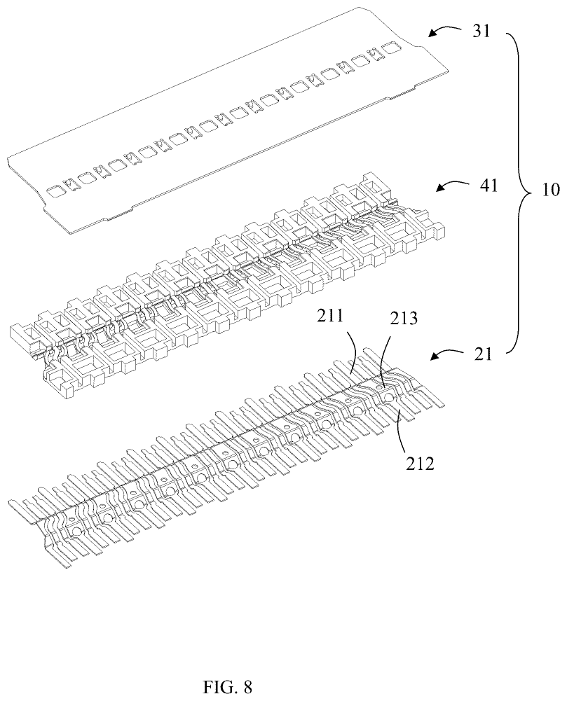

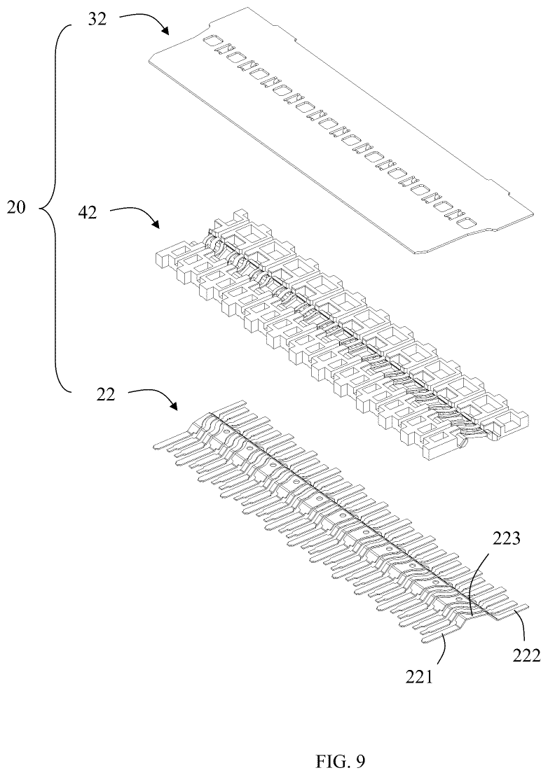

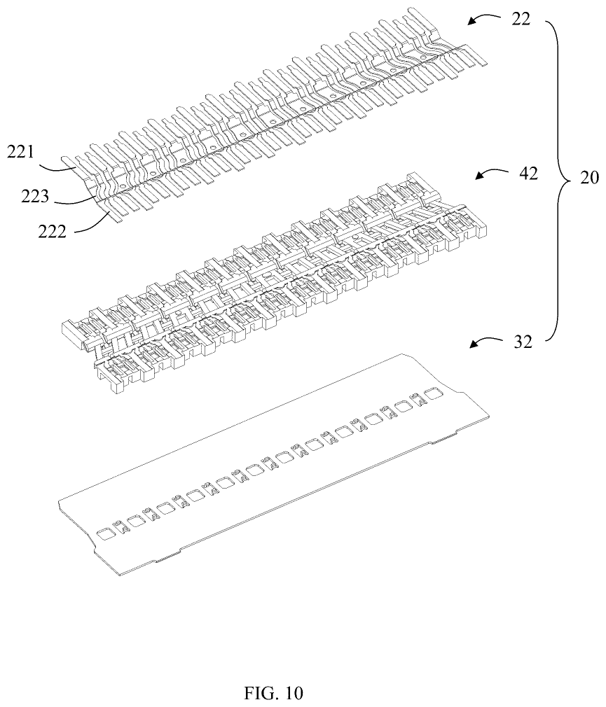

Referring to FIG. 1 to FIG. 11, a first embodiment of the present disclosure discloses a terminal module 100, including a plurality of first conductive terminals 21, an insulating body 1, and a first shielding piece 31. Specifically, in the first embodiment of the present disclosure, the terminal module 100 further includes a plurality of second conductive terminals 22 and a second shielding piece 32. Besides, to facilitate assembly, the terminal module 100 includes a first terminal assembly 10 and a second terminal assembly 20. The first terminal assembly 10 includes a first insulating block 41 fixed to the first conductive terminals 21 and the first shielding piece 31 to form an integral unit. Similarly, the second terminal assembly 20 includes a second insulating block 42 fixed to the second conductive terminals 22 and the second shielding piece 32 to form another integral unit. The terminal module 100 further includes a third insulating block 43 over-molded on the first terminal assembly 10 and the second terminal assembly 20. It is understandable to those skilled in the art that after the third insulating block 43 is molded on the first insulating block 41 and the second insulating block 42, the three components integrate into a single unit, collectively referred to as the insulating body 1.

In the first embodiment of the present disclosure, the first insulating block 41 is injection-molded on the first conductive terminals 21. Each first conductive terminal 21 includes a first conductive pad 211, a second conductive pad 212, and a first intermediate portion 213 connecting the first conductive pad 211 and the second conductive pad 212. The first conductive pad 211 and the second conductive pad 212 are disposed at intervals along a first direction A1-A1 (for example, a front-rear direction). In one application of the present disclosure, the first conductive pads 211 are configured to be in contact with a mating connector (not shown), while the second conductive pads 212 are configured to electrically connect to a cable (not shown), such as via soldering or welding. The first intermediate portion 213 includes a first embedded portion 2130 embedded in the insulating body 1 and spaced away from the first conductive pad 211 along a second direction A2-A2 (for example, a top-bottom direction). The second direction A2-A2 is perpendicular to the first direction A1-A1.

The insulating body 1 includes a first surface 11 and a second surface 12 disposed opposite to the first surface along the second direction A2-A2. In the illustrated embodiment of the present disclosure, both the first conductive pad 211 and the second conductive pad 212 are exposed on the first surface 11. In one embodiment of the present disclosure, a first outer surface 2111 (for example, an upper surface) of the first conductive pad 211 and a second outer surface 2121 (for example, an upper surface) of the second conductive pad 212 lie in a same plane. Alternatively, the first outer surface 2111 of the first conductive pad 211 and the second outer surface 2121 of the second conductive pad 212 may lie in different planes. The first intermediate portion 213 extends from the first surface 11 toward the second surface 12 along the second direction A2-A2. In the illustrated embodiment of the present disclosure, the insulating body 1 further includes a first covering portion 13 covering the first intermediate portion 213. The first covering portion 13 is located between the first conductive pad 211 and the second conductive pad 212 along the first direction A1-A1. The first conductive pad 211, the first covering portion 13, and the second conductive pad 212 are substantially flat. It is understandable to those skilled in the art that a slight undulation among the first conductive pad 211, the first covering portion 13 and the second conductive pad 212, including, but not limited to, those caused by manufacturing variations, is still considered to be “substantially flat”. The first covering portion 13 has a third outer surface 131. Preferably, the first outer surface 2111, the second outer surface 2121 and the third outer surface 131 lie in the same plane.

Additionally, in the illustrated embodiment of the present disclosure, the second conductive pad 212 is deflected outward relative to the first conductive pad 211 along a third direction A3-A3 (for example, a left-right direction). The third direction A3-A3 is perpendicular to the first direction A1-A1 and the second direction A2-A2. Among the plurality of first conductive terminals 21, the second conductive pads 212 occupy a greater distance along the third direction A3-A3 than the first conductive pads 211 occupy along the third direction A3-A3. As a result, when the second conductive pads 212 and the cable are soldered or welded together, it is possible to reduce the risk of short-circuiting due to the small spacing between the second conductive pads 212.

In the illustrated embodiment of the present disclosure, the plurality of first conductive terminals 21 include a first signal terminal S1, a second signal terminal S2, a first ground terminal G1 and a second ground terminal G2. the first signal terminal S1 and the second signal terminal S2 are disposed adjacent to each other along the third direction A3-A3 and form a first signal terminal group. The first ground terminal G1 is located on one side of the first signal terminal group along the third direction A3-A3. The second ground terminal G2 is located on another side of the first signal terminal group along the third direction A3-A3. The terminal layout of G1-S1-S2-G2 of the present disclosure facilitates improved quality of signal transmission. In the illustrated embodiment of the present disclosure, in order to provide a better ground shielding effect, the first conductive pad 211 of the first ground terminal G1 as well as the first conductive pad 211 of the second ground terminal G2 extend forwardly beyond the first conductive pad 211 of the first signal terminal S1 and the first conductive pad 211 of the second signal terminal S2 in the first direction A1-A1. Besides, the second conductive pad 212 of the first ground terminal G1 and the second conductive pad 212 of the second ground terminal G2 both extend backwardly beyond the second conductive pad 212 of the first signal terminal S1 and the second conductive pad 212 of the second signal terminal S2 along the first direction A1-A1.

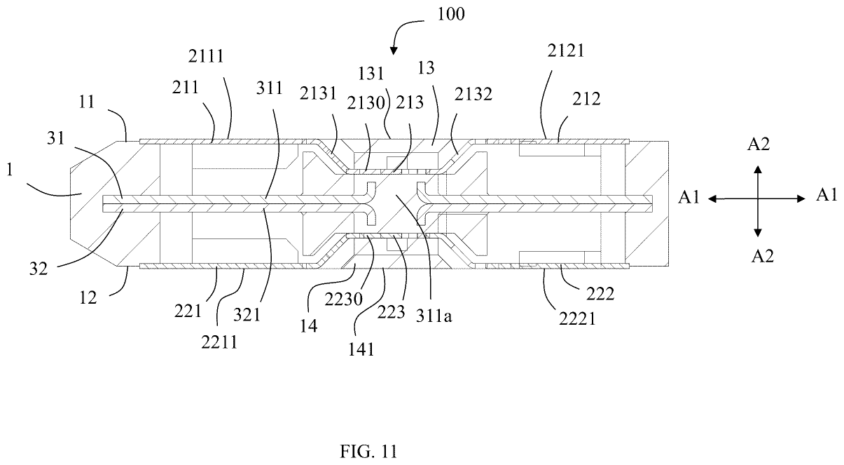

The first shielding piece 31 is made of a metallic material, and includes a first plate portion 311 at least partially embedded in the insulating body 1. The first embedded portion 2130 is located between the first conductive pad 211 and the first plate portion 311 along the second direction A2-A2. As a result, the first embedded portion 2130 is able to function as a conductive path similar to conductive traces of a printed circuit board. As shown in FIG. 11, in the illustrated embodiment of the present disclosure, the first plate portion 311 extends forwardly beyond the first conductive pad 211 along the first direction A1-A1, and the first plate portion 311 extends backwardly beyond the second conductive pad 212 along the first direction A1-A1 to provide a better shielding effect over the entire length of the first conductive pad 211 as well as the second conductive pad 212.

In the first embodiment of the present disclosure, the first plate portion 311 defines a first opening 311a extending through the first plate portion 311 along the second direction A2-A2. The first shielding piece 31 is either assembled to the first insulating block 41, or the first insulating block 41 is inject-molded on the first shielding piece 31.

Specifically, the first intermediate portion 213 includes a first connecting portion 2131 connected between the first embedded portion 2130 and the first conductive pad 211, and a second connecting portion 2132 connected between the first embedded portion 2130 and the second conductive pad 212.

In the first embodiment of the present disclosure, both the first connecting portion 2131 and the second connecting portion 2132 are inclined. The first embedded portion 2130 is flat. In the first embodiment of the present disclosure, each of the first embedded portion 2130 of the first ground terminal G1 and the first embedded portion 2130 of the second ground terminal G2 defines a first through hole 2130a extending through the first embedded portion 2130 in the second direction A2-A2. The insulating body 1 fills the first through hole 2130a and the first opening 311a to enhance the retention force.

In various embodiments illustrated in the present disclosure, the second terminal assembly 20 is symmetrically arranged with the first terminal assembly 10. That is, the first conductive terminals 21 are symmetrically arranged with the second conductive terminals 22, and the first shielding piece 31 is arranged symmetrically with the second shielding piece 32. Preferably, the first terminal assembly 10 is identical to the second terminal assembly 20 to be able to share parts and save costs.

The second conductive terminal 22 includes a third conductive pad 221, a fourth conductive pad 222, and a second intermediate portion 223 connecting the third conductive pad 221 and the fourth conductive pad 222. The third conductive pad 221 and the fourth conductive pad 222 are disposed at intervals in the first direction A1-A1. The second intermediate portion 223 extends from the second surface 12 toward the first surface 11 in the second direction A2-A2. The second intermediate portion 223 includes a second embedded portion 2230 embedded in the insulating body 1 and disposed away from the third conductive pad 221 in the second direction A2-A2.

In one embodiment of the present disclosure, the fourth outer surface 2211 (for example, a lower surface) of the third conductive pad 221 is located in the same plane as the fifth outer surface 2221 (for example, a lower surface) of the fourth conductive pad 222. In the illustrated embodiment of the present disclosure, the insulating body 1 includes a second covering portion 14 covering the second intermediate portion 223. The second covering portion 14 is located between the third conductive pad 221 and the fourth conductive pad 222 in the first direction A1-A1. The third conductive pad 221, the second covering portion 14 and the fourth conductive pad 222 are substantially flat. It is understandable to those skilled in the art that a slight undulation among the third conductive pad 221, the second covering portion 14 and the fourth conductive pad 222 including, but not limited to, those caused by manufacturing variations, is still considered to be “substantially flat”. The second covering portion 14 has a sixth outer surface 141. Preferably, the sixth outer surface 141 of the second covering portion 14, the fourth outer surface 2211 of the third conductive pad 221, and the fifth outer surface 2221 of the fourth conductive pad 222 are located in the same plane.

The second shielding piece 32 includes a second plate portion 321 at least partially embedded in the insulating body 1. The second embedded portion 2230 is located between the third conductive pad 221 and the second plate portion 321 in the second direction A2-A2.

Other structures of the second terminal assembly 20 may refer to the description of the first terminal assembly 10, which will not be repeated in the present disclosure.

In order to improve the shielding effect, in various embodiments of the present disclosure, the first plate portion 311 of the first shielding piece 31 is electrically connected to the second plate portion 321 of the second shielding piece 32. For example, the first plate portion 311 of the first shielding piece 31 is in contact with the second plate portion 321 of the second shielding piece 32.

In the first embodiment of the present disclosure, the first shielding piece 31 is not in contact with the first ground terminal G1 and the second ground terminal G2.

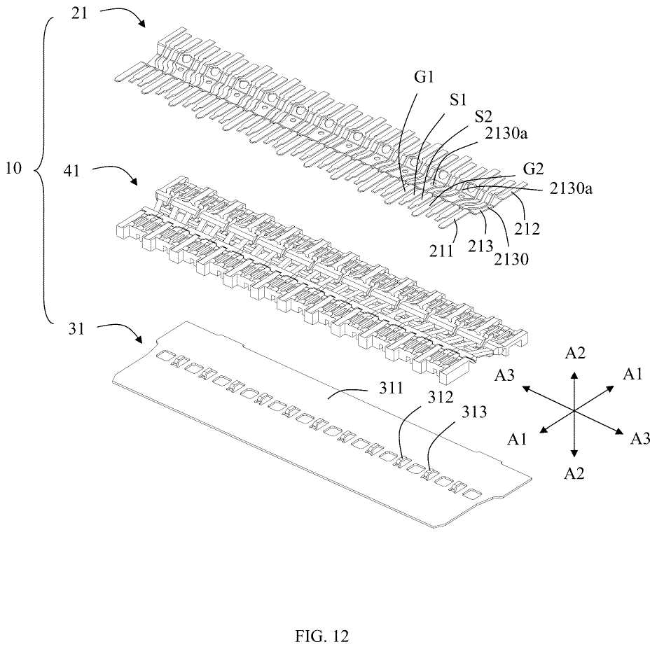

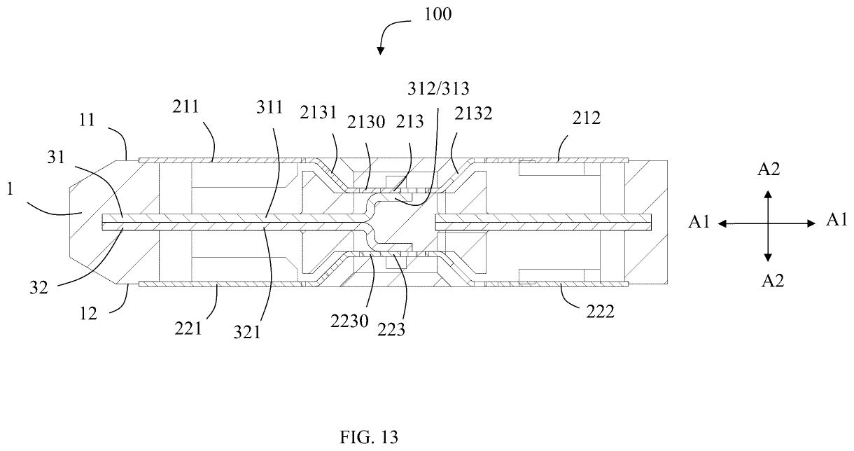

Referring to FIG. 12 and FIG. 13, in a second embodiment of the present disclosure, the first shielding piece 31 is electrically connected to the first embedded portion 2130 of the first ground terminal G1. The first shielding piece 31 is electrically connected to the first embedded portion 2130 of the second ground terminal G2. Specifically, the first shielding piece 31 is provided with a first protrusion tab 312 in contact with the first embedded portion 2130 of the first ground terminal G1, and a second protrusion tab 313 in contact with the first embedded portion 2130 of the second ground terminal G2. Preferably, the first protrusion tab 312 and the second protrusion tab 313 are formed by integrally stamping from the first embedded portion 2130.

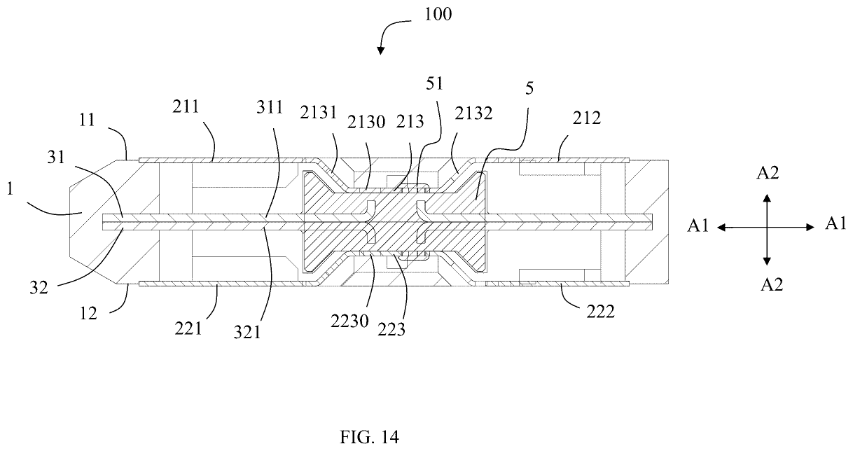

Referring to FIG. 14, in a third embodiment of the present disclosure, the first shielding piece 31 is electrically connected to the first embedded portion 2130 of the first ground terminal G1. The first shielding piece 31 is electrically connected to the first embedded portion 2130 of the second ground terminal G2. Specifically, the terminal module 100 is provided with a first conductive block 5 fixed to the first shielding piece 31 and the second shielding piece 32. The first conductive block 5 is made of a metal conductor or a wave absorbing material. The first conductive block 5 connects the first shielding piece 31 and the first embedded portion 2130 of the first ground terminal G1, and the first conductive block 5 connects the first shielding piece 31 and the first embedded portion 2130 of the second ground terminal G2. Each of the first embedded portion 2130 of the first ground terminal G1 and the first embedded portion 2130 of the second ground terminal G2 defines a first through hole 2130a. The first conductive block 5 includes a plurality of first mounting posts 51 fixed in corresponding first through holes 2130a.

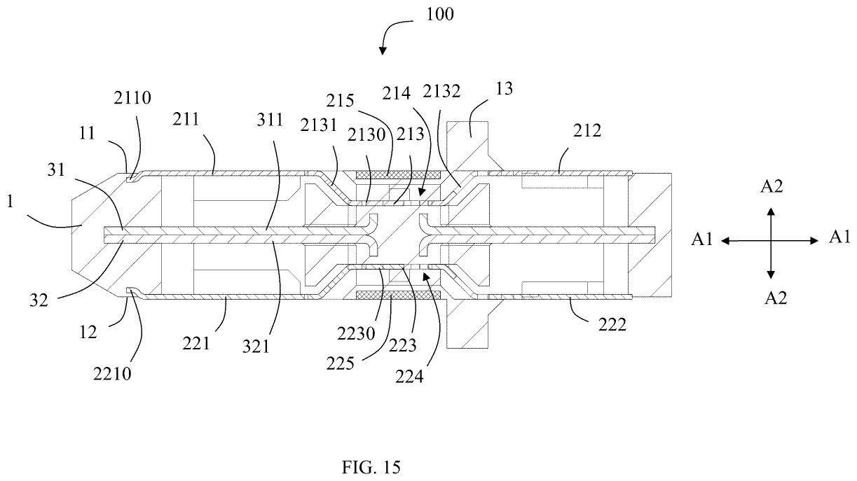

Referring to FIG. 15, in a fourth embodiment of the present disclosure, the first conductive terminal 21 includes a first recess 214 located outside (for example, an upper end) the first intermediate portion 213 in the second direction A2-A2. The first recess 214 is located between the first conductive pad 211 and the second conductive pad 212 in the first direction A1-A1. Similarly, the second conductive terminal 22 includes a second recess 224 located outside (for example, a lower end) of the second intermediate portion 223 in the second direction A2-A2. The second recess 224 is located between the third conductive pad 221 and the fourth conductive pad 222 in the first direction A1-A1.

The terminal module 100 further includes a first shielding plate 215 fixed to the insulating body 1 and corresponding to the first recess 214, and a second shielding plate 225 fixed to the insulating body 1 and corresponding to the second recess 224. The first shielding plate 215 is exposed on the first surface 11. The second shielding plate 225 is exposed on the second surface 12. By providing the first shielding plate 215 and the second shielding plate 225, it is beneficial to further improve the shielding effect and improve the quality of signal transmission. At this time, the insulating body 1 may also be provided with a first holding protrusion 13 extending upwardly beyond the first surface 11. Preferably, the first holding protrusion 13 presses against a joint between the second connecting portion 2132 and the second conductive pad 212 to increase the retention force between the first conductive terminal 21 and the first insulating block 41, thereby reducing the risk of loosening between the two.

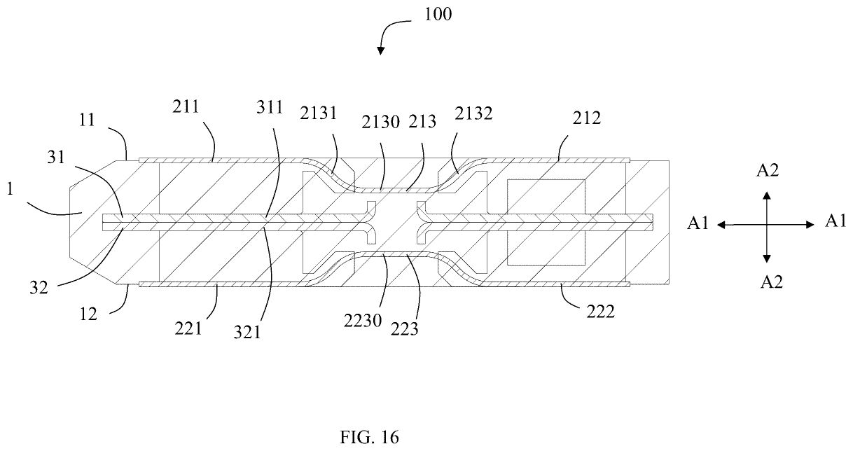

Referring to FIG. 16, in a fifth embodiment of the present disclosure, the first embedded portion 2130 is of an arc shape. The first connecting portion 2131 is of an arc shape. The second connecting portion 2132 is of an arc shape. As a result, the first intermediate portion 213 itself, the connection position of the first intermediate portion 213 and the first conductive pad 211, and the connection position of the first intermediate portion 213 and the second conductive pad 212 can be smoothly over.

Referring to FIG. 15, it is understandable to those skilled in the art that in order to increase the retention force between the first conductive terminal 21 and the first insulating block 41, and reduce the risk of loosening between the two, the first conductive terminal 21 may also include a first retaining portion 2110 connected to the first conductive pad 211. In the illustrated embodiment of the present disclosure, the first retaining portion 2110 and the first conductive pad 211 are in a step shape. That is, the first retaining portion 2110 and the first conductive pad 211 are not in a same plane. As a result, although the first conductive pad 211 needs to be exposed on the first surface 11, the first retaining portion 2110 may still be embedded and fixed in the insulating body 1 to increase the retention force. Based on the same design concept, the insulating body 1 can also add a first retaining portion of a raised feature to cover the upper surface of the corresponding portion of the first conductive terminal 21 to increase the retention force and prevent the first conductive terminal 21 from being peeled off. Of course, it is understandable to those skilled in the art that the shape of the first retaining portion 2110 can be flexibly adjusted as needed, for example, bent in an inclined or arced surface.

Similarly, referring to FIG. 15, it is understandable to those skilled in the art that in order to increase the retention force between the second conductive terminal 22 and the second insulating block 42, and reduce the risk of loosening between the two, the second conductive terminal 222 may also include a second retaining portion 2210 connected to the third conductive pad 221. In the illustrated embodiment of the present disclosure, the second retaining portion 2210 and the third conductive pad 221 are in a step shape. That is, the second retaining portion 2210 and the third conductive pad 221 are not in a same plane. As a result, although the third conductive pad 221 needs to be exposed on the second surface 12, the second retaining portion 2210 may still be embedded and fixed in the insulating body 1 to increase the retention force. Based on the same design concept, the insulating body 1 can also add a second retaining portion of a raised feature to cover the lower surface of the corresponding portion of the second conductive terminal 22 to increase the retention force and prevent the second conductive terminal 22 from being peeled off. Of course, it is understandable to those skilled in the art that the shape of the second retaining portion 2210 can be flexibly adjusted as needed, for example, bent in an inclined or arced surface.

By providing the first retaining portion 2110 and the second retaining portion 2210, and securing them with the first insulating block 41 and the second insulating block 42, respectively, the present disclosure is conducive to improving the mating reliability of the first conductive pad 211 and the third conductive pad 221.

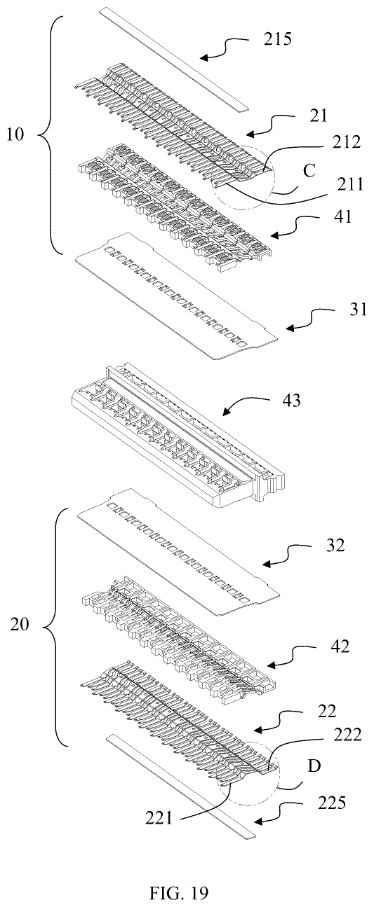

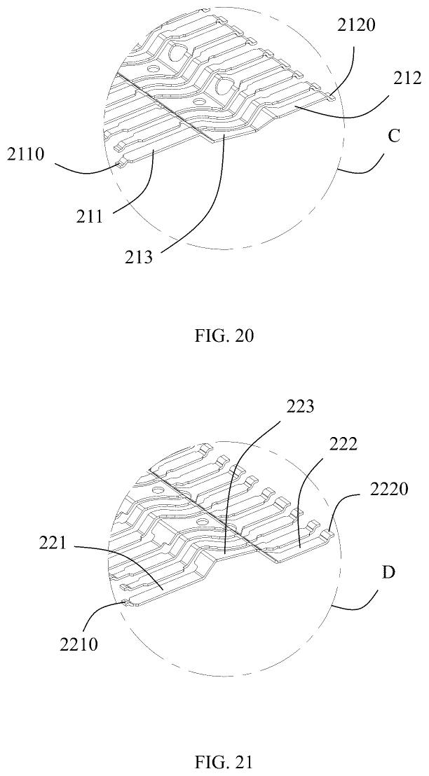

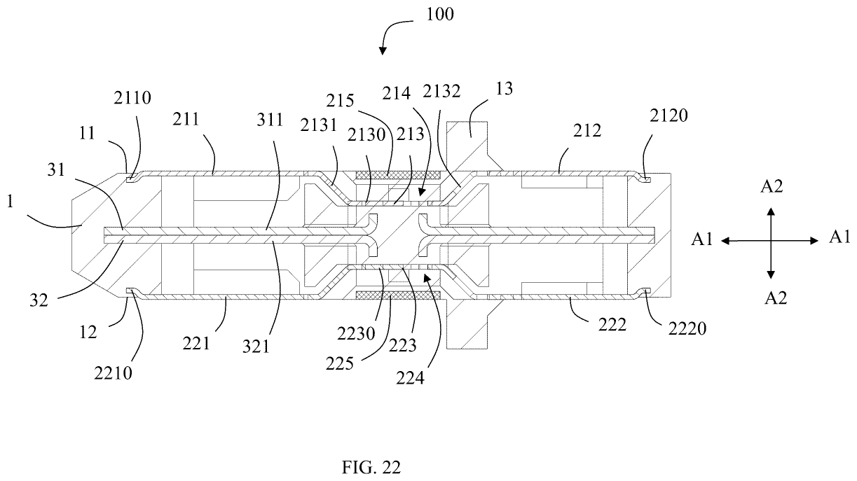

Referring to FIG. 19 to FIG. 22, the terminal module in a sixth embodiment of the present disclosure is similar to the terminal module in the fourth embodiment shown in FIG. 15. The following describes only the main differences between the two.

Referring to FIG. 19 to FIG. 22, in the sixth embodiment of the present disclosure, it is understandable to those skilled in the art that in order to increase the retention force between the first conductive terminal 21 and the first insulating block 41, and reduce the risk of loosening between the two, the first conductive terminal 21 may also include a first fixing portion 2120 connected to the second conductive pad 212. In the illustrated embodiment of the present disclosure, the first fixing portion 2120 and the second conductive pad 212 are in a step shape. That is, the first fixing portion 2120 and the second conductive pad 212 are not in a same plane. As a result, although the second conductive pad 212 needs to be exposed on the first surface 11, the first fixing portion 2120 can still be embedded and fixed in the insulating body 1 to increase the retention force. Based on the same design concept, the insulating body 1 can also add a third retaining portion of a raised feature to cover the upper surface of the corresponding portion of the first conductive terminal 21 to increase the retention force and prevent the first conductive terminal 21 from being peeled off. As a result, the present disclosure improves the structural reliability when the second conductive pad 212 is electrically connected (for example, soldered or welded) to a cable. Of course, it is understandable to those skilled in the art that the shape of the first fixing portion 2120 can be flexibly adjusted as needed, for example, bent in an inclined or arced surface.

Similarly, referring to FIG. 19 to FIG. 22, in the sixth embodiment of the present disclosure, it is understandable to those skilled in the art that in order to increase the retention force between the second conductive terminal 22 and the second insulating block 42, and reduce the risk of loosening between the two, the second conductive terminal 22 may also include a second fixing portion 2220 connected to the fourth conductive pad 2222. In the illustrated embodiment of the present disclosure, the second fixing portion 2220 and the fourth conductive pad 222 are in a step shape. That is, the second fixing portion 2220 and the fourth conductive pad 222 are not in a same plane. As a result, although the fourth conductive pad 222 needs to be exposed on the second surface 12, the second fixing portion 2220 can still be embedded and fixed in the insulating body 1 to increase the retention force. Based on the same design concept, the insulating body 1 can also add a fourth retaining portion of a raised feature to cover the lower surface of the corresponding portion of the second conductive terminal 22 to increase the retention force and prevent the second conductive terminal 22 from being peeled off. The present disclosure improves the structural reliability of the fourth conductive pad 222 when the fourth conductive pad 222 is electrically connected (for example, soldered or welded) to a cable. Of course, it is understandable to those skilled in the art that the shape of the second fixing portion 2220 can be flexibly adjusted as needed, for example, bent in an inclined or arced surface.

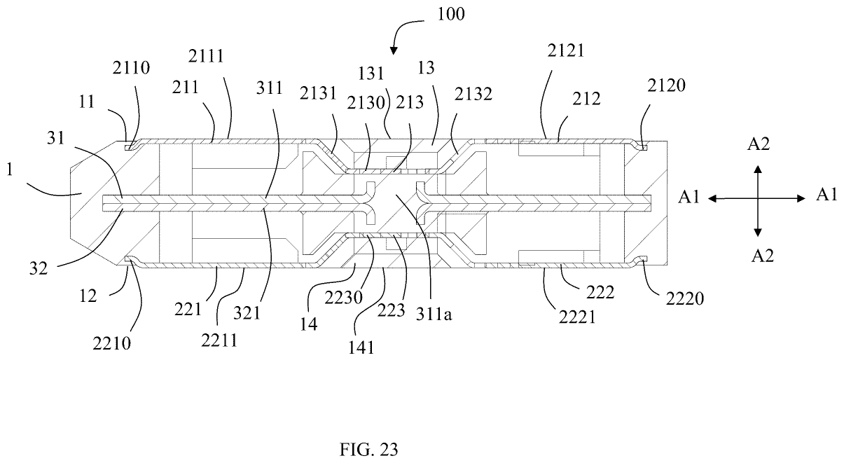

Referring to FIG. 23, the terminal module in a seventh embodiment of the present disclosure is similar to the terminal module in the first embodiment shown in FIG. 11, and the following will only describe the main differences between the two.

Referring to FIG. 23, it is understandable to those skilled in the art that in order to increase the retaining force between the first conductive terminal 21 and the first insulating block 41, and reduce the risk of loosening between the two, the first conductive terminal 21 may also include a first retaining portion 2110 connected to the first conductive pad 211 and a first retaining portion 2120 connected to the second conductive pad 212. In the illustrated embodiment of the present disclosure, the first retaining portion 2110 and the first conductive pad 211 are in a step shape. That is, the first retaining portion 2110 and the first conductive pad 211 are not in a same plane. As a result, although the first conductive pad 211 needs to be exposed on the first surface 11, the first retaining portion 2110 may still be embedded and fixed in the insulating body 1 to increase the retaining force. Based on the same design concept, the insulating body 1 can also add a first retaining portion of a raised feature to cover the upper surface of the corresponding portion of the first conductive terminal 21 to increase the retention force and prevent the first conductive terminal 21 from being peeled off. Of course, it is understandable to those skilled in the art that the shapes of the first retaining portion 2110 and the first fixing portion 2120 can be flexibly adjusted as needed, for example, bent in an inclined or arced surface. The first fixing portion 2120 and the second conductive pad 212 are in a step shape. That is, the first fixing portion 2120 and the second conductive pad 212 are not in a same plane. As a result, although the second conductive pad 212 needs to be exposed on the first surface 11, the first fixing portion 2120 may still be embedded and fixed in the insulating body 1 to increase the retention force. Based on the same design concept, the insulating body 1 can also add a third retaining portion of a raised feature to cover the upper surface of the corresponding portion of the first conductive terminal 21 to increase the retention force and prevent the first conductive terminal 21 from being peeled off.

Similarly, referring to FIG. 23, it is understandable to those skilled in the art that in order to increase the retaining force between the second conductive terminal 22 and the second insulating block 42, and reduce the risk of loosening between the two, the second conductive terminal 222 may also include a second retaining portion 2210 connected to the third conductive pad 221 and a second fixing portion 2220 connected to the fourth conductive pad 222. In the illustrated embodiment of the present disclosure, the second retaining portion 2210 and the third conductive pad 221 are in a step shape. That is, the second retaining portion 2210 and the third conductive pad 221 are not in a same plane. As a result, although the third conductive pad 221 needs to be exposed on the second surface 12, the second retaining portion 2210 may still be embedded and fixed in the insulating body 1 to increase the retaining force. Based on the same design concept, the insulating body 1 can also add a second retaining portion of a raised feature to cover the lower surface of the corresponding portion of the second conductive terminal 22 to increase the retention force and prevent the second conductive terminal 22 from being peeled off. Of course, it is understandable to those skilled in the art that the shapes of the second retaining portion 2210 and the second fixing portion 2220 can be flexibly adjusted as needed, for example, bent in an inclined or arced surface. The second fixing portion 2220 and the fourth conductive pad 222 are in a step shape. That is, the second fixing portion 2220 and the fourth conductive pad 222 are not in a same plane. As a result, although the fourth conductive pad 222 needs to be exposed on the second surface 12, the second fixing portion 2220 can still be embedded and fixed in the insulating body 1 to increase the retention force. Based on the same design concept, the insulating body 1 can also add a fourth retaining portion of a raised feature to cover the lower surface of the corresponding portion of the second conductive terminal 22 to increase the retention force and prevent the second conductive terminal 22 from being peeled off.

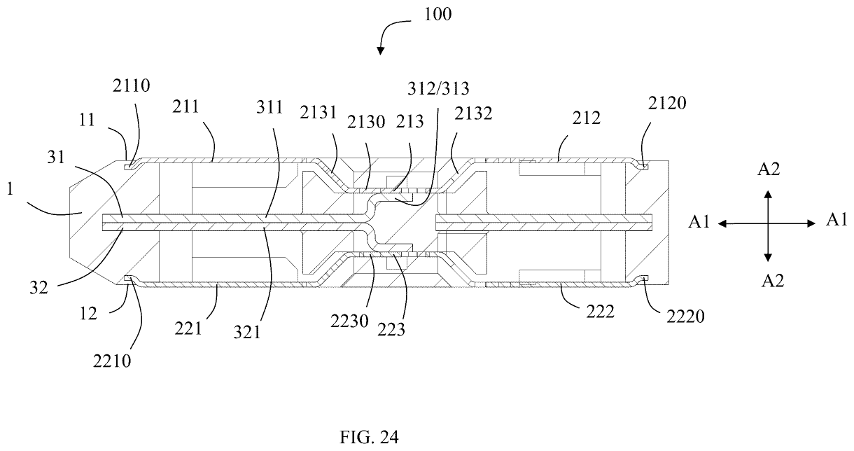

Referring to FIG. 24, the terminal module in an eighth embodiment of the present disclosure is similar to the terminal module in the second embodiment shown in FIG. 13. The main difference between the two is that in the terminal module in the eighth embodiment of the present disclosure, the first conductive terminal 21 may further include a first retaining portion 2110 connected to the first conductive pad 211 and a first fixing portion 2120 connected to the second conductive pad 212. The second conductive terminal 22 may further include a second retaining portion 2210 connected to the third conductive pad 221 and a second fixing portion 2220 connected to the fourth conductive pad 222. The structures and functions of the first retaining portion 2110, the first fixing portion 2120, the second retaining portion 2210 and the second fixing portion 2220 are the same as those in FIG. 23, which will not be described in detail in the present disclosure.

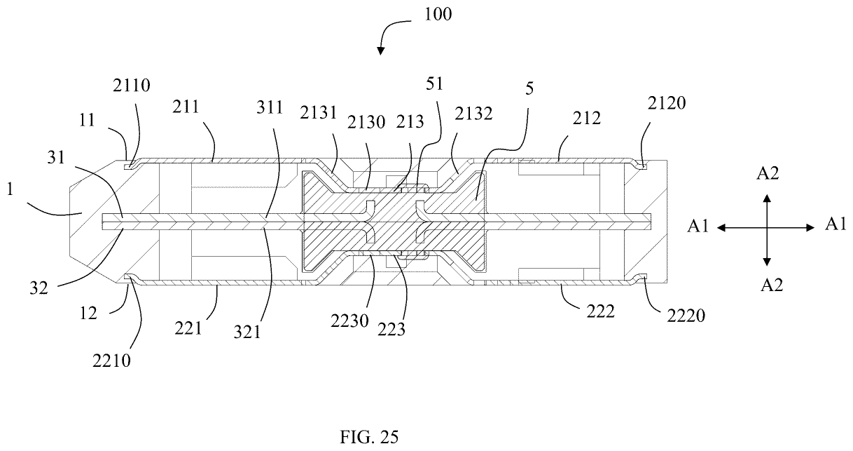

Referring to FIG. 25, the terminal module in a ninth embodiment of the present disclosure is similar to the terminal module in the third embodiment shown in FIG. 14. The main difference between the two is that, in the terminal module in the ninth embodiment of the present disclosure, the first conductive terminal 21 may further include a first retaining portion 2110 connected to the first conductive pad 211 and a first fixing portion 2120 connected to the second conductive pad 212. The second conductive terminal 22 may further include a second retaining portion 2210 connected to the third conductive pad 221, and a second fixing portion 2220 connected to the fourth conductive pad 222. The structures and functions of the first retaining portion 2110, the first fixing portion 2120, the second retaining portion 2210, and the second fixing portion 2220 are the same as those in FIG. 23, which will not be described in detail in the present disclosure.

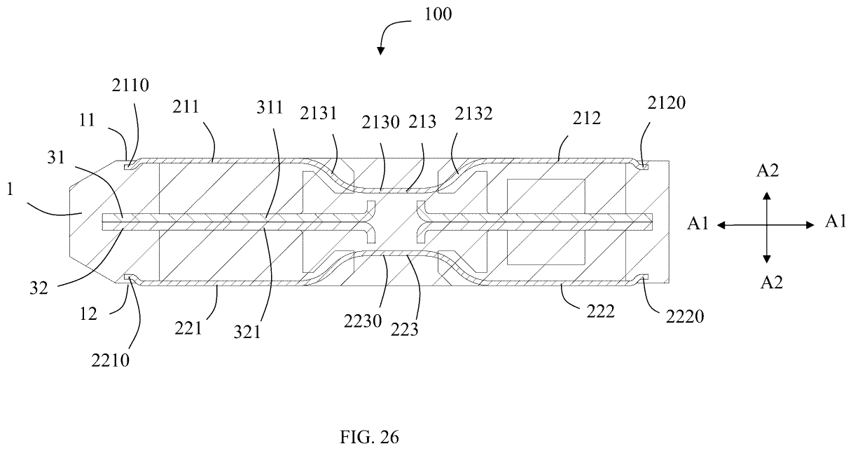

Referring to FIG. 26, the terminal module in a tenth embodiment of the present disclosure is similar to the terminal module in the fifth embodiment shown in FIG. 16. The main difference between the two is that, in the terminal module in the tenth embodiment of the present disclosure, the first conductive terminal 21 may further include a first retaining portion 2110 connected to the first conductive pad 211 and a first fixing portion 2120 connected to the second conductive pad 212. The second conductive terminal 22 may further include a second retaining portion 2210 connected to the third conductive pad 221, and a second fixing portion 2220 connected to the fourth conductive pad 222. The structures and functions of the first retaining portion 2110, the first fixing portion 2120, the second retaining portion 2210 and the second fixing portion 2220 are the same as those in FIG. 23, which will not be described in detail in the present disclosure.

The present disclosure also discloses a manufacturing method of the terminal module 100 described above, including:
providing the first conductive terminal 21;
providing the first shielding piece 31;
injection-molding the first insulating block 41 on the first conductive terminals 21 and the first shielding piece 31, so that the first conductive terminals 21, the first shielding piece 31 and the first insulating block 41 are combined into a first terminal assembly 10;
providing the second conductive terminal 22;
providing the second shielding piece 32;
injection-molding the second insulating block 42 on the second conductive terminals 22 and the second shielding piece 32, so that the second conductive terminals 22, the second shielding piece 32 and the second insulating block 42 are combined into a second terminal assembly 20;
assembling the first terminal assembly 10 and the second terminal assembly 20 together; and
injection-molding a third insulating block 43 on the first terminal assembly 10 and the second terminal assembly 20; wherein the third insulating block 43 is molded on the first insulating block 41 and the second insulating block 42 to form the insulating body 1.

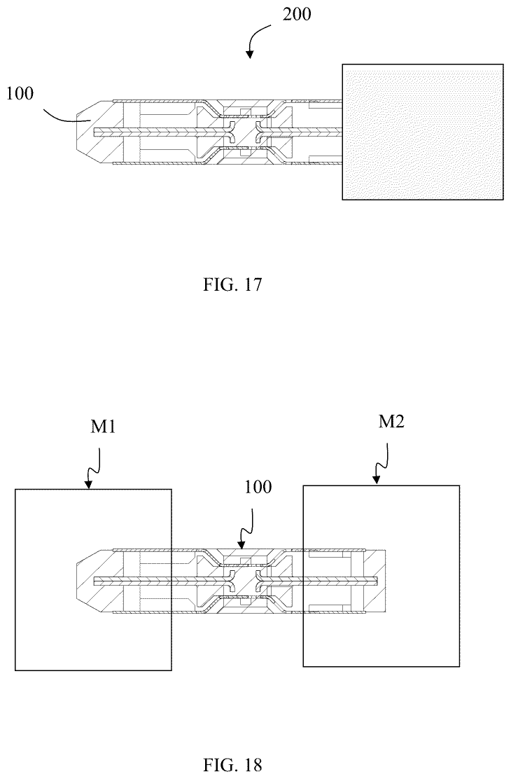

Referring to FIG. 17, the present disclosure also discloses an application of the above-mentioned terminal module 100. The terminal module 100 is a component of an electrical connector 200, replacing a printed circuit board. The component may be a tongue plate or an adapter module. When the component is the tongue plate, the tongue plate is used to be inserted into a slot of a mating connector. The first conductive pads 211 are used to be in contact with mating conductive terminals of the mating connector to achieve electrical connection.

Referring to FIG. 18, when the component is the adapter module, the first conductive pads 211 and the second conductive pads 212 serve as bridges to connect with a first component M1 and a second component M2, respectively.

Compared with the prior art, it is understandable to those skilled in the art that by embedding the first embedded portion 2130 in the insulating body 1, the first conductive terminal 21 can be better fixed to the insulating body 1, thereby reducing the risk of falling off between the two. In addition, the first embedded portion 2130 cooperates with the insulating body 1 to facilitate adjustment of impedance. The terminal module 100 of the present disclosure is able to replace the printed circuit board in the related art, so as to better be adaptable to the development requirements of high-speed connectors in terms of dimension control and impedance adjustment.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A terminal module, comprising:
a plurality of first conductive terminals, each first conductive terminal comprising a first conductive pad, a second conductive pad, and a first intermediate portion connecting the first conductive pad and the second conductive pad; the first conductive pad and the second conductive pad being disposed at intervals along a first direction;
an insulating body, the insulating body comprising a first surface and a second surface disposed opposite to the first surface along a second direction that is perpendicular to the first direction; the first conductive pad being exposed on the first surface; the first intermediate portion extending from the first surface toward the second surface along the second direction; the first intermediate portion comprising a first embedded portion embedded in the insulating body and spaced away from the first conductive pad along the second direction; and
a first shielding piece, the first shielding piece comprising a first plate portion at least partially embedded in the insulating body; the first embedded portion being located between the first conductive pad and the first plate portion along the second direction.

2. The terminal module according to claim 1, wherein the second conductive pad is exposed on the first surface; and a first outer surface of the first conductive pad and a second outer surface of the second conductive pad lie in a same plane.

3. The terminal module according to claim 2, wherein the insulating body comprises a first covering portion covering the first intermediate portion; the first covering portion is located between the first conductive pad and the second conductive pad along the first direction; the first covering portion having a third outer surface lying in the same plane as the first outer surface and the second outer surface.

4. The terminal module according to claim 1, wherein the second conductive pad is deflected outward relative to the first conductive pad along a third direction; and the third direction is perpendicular to the first direction and the second direction.

5. The terminal module according to claim 4, wherein, among the plurality of first conductive terminals, the second conductive pads occupy a greater distance along the third direction than the first conductive pads occupy along the third direction.

6. The terminal module according to claim 1, wherein the plurality of first conductive terminals comprise a first signal terminal, a second signal terminal, a first ground terminal, and a second ground terminal; the first signal terminal and the second signal terminal are disposed adjacent to each other along a third direction to form a first signal terminal group; the first ground terminal is located on one side of the first signal terminal group along the third direction, and the second ground terminal is located on another side of the first signal terminal group along the third direction.

7. The terminal module according to claim 6, wherein the first conductive pad of the first ground terminal and the first conductive pad of the second ground terminal both extend forwardly beyond the first conductive pad of the first signal terminal and the first conductive pad of the second signal terminal along the first direction.

8. The terminal module according to claim 6, wherein the second conductive pad of the first ground terminal and the second conductive pad of the second ground terminal both extend rearwardly beyond the second conductive pad of the first signal terminal and the second conductive pad of the second signal terminal along the first direction.

9. The terminal module according to claim 6, wherein the first embedded portion comprises a first through hole extending through the first embedded portion along the second direction;
the first plate portion comprises a first opening extending through the first plate portion along the second direction; and
the insulating body fills the first through hole and the first opening.

10. The terminal module according to claim 6, wherein the first shielding piece is electrically connected to the first embedded portion of the first ground terminal and the first embedded portion of the second ground terminal.

11. The terminal module according to claim 10, wherein the first shielding piece comprises a first protrusion tab being in contact with the first embedded portion of the first ground terminal, and a second protrusion tab being in contact with the first embedded portion of the second ground terminal.

12. The terminal module according to claim 10, further comprising a first conductive block fixed to the first shielding piece; the first conductive block electrically connects the first shielding piece to the first embedded portion of the first ground terminal; and the first conductive block electrically connects the first shielding piece to the first embedded portion of the second ground terminal.

13. The terminal module according to claim 1, wherein the first intermediate portion comprises a first connecting portion connected between the first embedded portion and the first conductive pad, and a second connecting portion connected between the first embedded portion and the second conductive pad;
wherein the first connecting portion and/or the second connecting portion is inclined or curved.

14. The terminal module according to claim 1, wherein the first conductive terminal comprises a first recess located outside the first intermediate portion along the second direction; the first recess is disposed between the first conductive pad and the second conductive pad along the first direction;
wherein the terminal module further comprises a first shielding plate fixed to the insulating body and disposed corresponding to the first recess; the first shielding plate is exposed on the first surface.

15. The terminal module according to claim 1, wherein the first conductive pad is configured to be in contact with a mating connector, and the second conductive pad is configured to be electrically connected to a cable.

16. The terminal module according to claim 1, further comprising:
a plurality of second conductive terminals, each second conductive terminal comprising a third conductive pad, a fourth conductive pad, and a second intermediate portion connecting the third conductive pad and the fourth conductive pad; the third conductive pad and the fourth conductive pad being disposed at intervals along the first direction; the second intermediate portion extending from the second surface toward the first surface along the second direction; the second intermediate portion comprising a second embedded portion embedded in the insulating body and spaced away from the third conductive pad along the second direction; and
a second shielding piece, the second shielding piece comprising a second plate portion at least partially embedded in the insulating body; the second embedded portion being located between the third conductive pad and the second plate portion along the second direction; the first plate portion of the first shielding piece being electrically connected to the second plate portion of the second shielding piece.

17. The terminal module according to claim 16, wherein each first conductive terminal comprises a first retaining portion connected to the first conductive pad and a first fixing portion connected to the second conductive pad; the first retaining portion and the first conductive pad are in a step shape; and the first fixing portion and the second conductive pad are in a step shape;
each second conductive terminal comprises a second retaining portion connected to the third conductive pad and a second fixing portion connected to the fourth conductive pad; the second retaining portion and the third conductive pad are in a step shape; and the second fixing portion and the fourth conductive pad are in a step shape; and
the first retaining portion, the first fixing portion, the second retaining portion and the second fixing portion are embedded in the insulating body.

18. A method for manufacturing the terminal module according to claim 16, comprising:
providing the plurality of first conductive terminals;
providing the first shielding piece;
injection-molding a first insulating block on the first conductive terminals and the first shielding piece to form a first terminal assembly;
providing the plurality of second conductive terminals;
providing the second shielding piece;
injection-molding a second insulating block on the second conductive terminals and the second shielding piece to form a second terminal assembly;
assembling the first terminal assembly and the second terminal assembly together; and
injection-molding a third insulating block on the first terminal assembly and the second terminal assembly to form the insulating body.

19. An application of the terminal module according to claim 16, wherein the terminal module is a component of an electrical connector, and the terminal module is configured to replace a printed circuit board.

20. The application according to claim 19, wherein the component is a tongue plate or an adapter module.
